(19) United States
(12) Patent Application Publication
(10) Pub. No.: US 2025/0132462 A1
(43) Pub. Date: Apr. 24, 2025

(54) ALL-SOLID-STATE BATTERY

(71) Applicant: HONDA MOTOR CO., LTD., Tokyo (JP)

(72) Inventors: Sachio SUZUKI, Saitama (JP); Kenta KASANO, Saitama (JP); Tatsuya HASHIMOTO, Saitama (JP)

(21) Appl. No.: 18/918,104

(22) Filed: Oct. 17, 2024

(30) Foreign Application Priority Data
Oct. 19, 2023 (JP) 2023-180575

(51) Int. Cl. H01M 50/474; H01M 10/0585; H01M 50/486

(52) U.S. Cl. CPC H01M 50/474; H01M 10/0585; H01M 50/486

(57) ABSTRACT

An all-solid-state battery is provided that can ensure adequate insulation even in a situation in which tab wires extending from negative electrode current collectors are gathered in order for the function as a battery to be performed, and a clearance between the tab wires and a positive electrode current collector is short due to bend of the tab wires. The all-solid-state battery includes an electrode body including a positive electrode current collector, a positive electrode layer, a solid electrolyte layer, a negative electrode layer, and a negative electrode current collector that are stacked in this order. The battery further includes a first insulating material at an end of the positive electrode layer, and a second insulating material at a portion that is between the negative electrode current collector and the solid electrolyte layer and faces an end of the solid electrolyte layer and an end of the first insulating material.

This application is based on and claims the benefit of priority from Japanese Patent Application No. 2023-180575, filed on 19 Oct. 2023, the content of which is incorporated herein by reference.

### BACKGROUND OF THE INVENTION

### Field of the Invention

The present invention relates to an all-solid-state battery.

### Related Art

In recent years, research and development of secondary batteries that contribute to energy efficiency has been carried out in order to ensure more people have access to affordable, reliable, sustainable, and advanced energy. Among the secondary batteries, lithium metal batteries have drawn attention because of their high energy densities.

Lithium metal batteries are secondary batteries that include lithium metal as a negative electrode, and can be configured as high-capacity batteries. Among them, so-called all-solid-state lithium metal batteries that are in an all solid state by way of replacement of an electrolytic solution with a solid electrolyte layer have drawn attention for their excellence in safety. The all-solid-state lithium metal battery has a cell structure that includes, for example, a negative electrode made of lithium metal; a positive electrode; and a solid electrolyte layer.

FIG. 5 is a cross-sectional view showing the configuration of a conventional all-solid-state battery. The all-solid-state battery 1 shown in FIG. 5 includes: a negative electrode formed of a negative electrode current collector 2a and a lithium metal layer (negative electrode layer) 3a, or a negative electrode current collector 2b and a lithium metal layer (negative electrode layer) 3b; a positive electrode formed of a positive electrode current collector 40 and a positive electrode active material layer (positive electrode layer) 5a or 5b; and solid electrolyte layers 6a and 6b adjacent to the positive electrode active material layer (positive electrode layer) 5a or 5b. The all-solid-state battery 1 shown in FIG. 5 includes an intermediate layer 7a between the lithium metal layer (negative electrode layer) 3a and the solid electrolyte layer 6a, and includes an intermediate layer 7b between the lithium metal layer (negative electrode layer) 3b and the solid electrolyte layer 6b. First insulating materials 8a and 8c are respectively disposed at the opposite ends of the positive electrode active material layer (positive electrode layer) 5a. First insulating materials 8b and 8d are respectively disposed at the opposite ends of the positive electrode active material layer 5b. Reference symbol L denotes the stacking direction of layers constituting the all-solid-state battery 1.

The all-solid-state battery includes an electrode body that includes such cell structures stacked together, and tab wires extending from the negative electrode current collectors of the cell structures are gathered, whereby function as a battery is performed. When the tab wires are gathered, the tab wires extending from the electrode body are bent. In particular, the tab wires distant from the gathering portion have a large curvature. As a result, the clearance between the tab wires and the positive electrode current collector is short, and there has been a concern that a sufficient insulation distance could not be ensured.

Japanese Unexamined Patent Application, Publication No. 2022-104116 discloses an all-solid-state battery that includes an electrode body having a positive electrode collector foil, a positive electrode layer, a solid electrolyte layer, a negative electrode layer, and a negative electrode current collector foil which are stacked in this order. In the electrode body, the positive electrode layer is stacked so as to be disposed inward with respect to the solid electrolyte layer and the negative electrode layer, and an insulating layer is disposed on a portion of a surface of the positive electrode collector foil closer to the positive electrode layer, the portion facing at least ends of the solid electrolyte layer and negative electrode layer.

The insulating layer applied to the all-solid-state battery described in Japanese Unexamined Patent Application, Publication No. 2022-104116 has a configuration in which a ceramic layer adheres to the positive electrode collector foil via an adhesion layer. The ceramic layer, which has a high hardness, suppresses breakage of the insulating layer the can be cause by metal foreign substances, thus suppressing electrical short circuits. Even if an electrical short circuit occurs, an advantageous effect that the high resistance of the ceramic layer suppresses heat generation by the electrical short circuit is expected.

However, since the insulating layer described in Japanese Unexamined Patent Application, Publication No. 2022-104116 includes the ceramic layer, it is not intended to use the insulating layer in a bent state.

Patent Document 1: Japanese Unexamined Patent Application, Publication No. 2022-104116

### SUMMARY OF THE INVENTION

The present invention has an object to provide an all-solid-state battery that can ensure adequate insulation even in a situation in which tab wires extending from negative electrode current collectors of cell structures are gathered in order for the function as a battery to be performed and a clearance between the tab wires and a positive electrode current collector is short due to bend of the tab wires.

The present inventors have made a diligent study in order to achieve the object described above. The inventors have found that in an all-solid-state battery including an electrode body that includes a positive electrode current collector, a positive electrode layer, a solid electrolyte layer, a negative electrode layer, and a negative electrode current collector that are stacked in this order, a first insulating material is arranged at an end of the positive electrode layer, a second insulating material is arranged at a portion that is between the negative electrode current collector and the solid electrolyte layer and faces an end of the solid electrolyte layer and an end of the first insulating material, and a creepage distance from a surface of the negative electrode current collector closer to the negative electrode layer to a surface of the positive electrode current collector closer to the positive electrode layer is greater than a straight-line distance therebetween, thus ensuring adequate insulation by the creepage distance, and have thus completed the present invention.

That is, the present invention includes the following aspects.

[1] An all-solid-state battery includes an electrode body including a positive electrode current collector, a positive electrode layer, a solid electrolyte layer, a negative electrode layer, and a negative electrode current collector that are stacked in this order. The positive electrode current collector includes, on a surface thereof closer to the positive electrode layer, a first insulating material adjacent to an end of the positive electrode layer, the solid electrolyte layer is disposed in contact with the positive electrode layer and the first insulating material, a second insulating material is arranged at a portion that is between the negative electrode current collector and the solid electrolyte layer and faces an end of the solid electrolyte layer and an end of the first insulating material, and the second insulating material is disposed in contact with the solid electrolyte layer such that a creepage distance from a surface of the negative electrode current collector closer to the negative electrode layer to a surface of the positive electrode current collector closer to the positive electrode layer is greater than a straight-line distance therebetween.
[2] According to the all-solid-state battery of aspect [1], in the first insulating material, as a distance in an extending direction of the electrode body from an end adjacent to the positive electrode layer increases, a thickness in a stacking direction of the electrode body decreases.
[3] In the all-solid-state battery according to aspect [1] or [2], the second insulating material is disposed so as to overlap with an end of the negative electrode layer in an extending direction of the electrode body.
[4] In the all-solid-state battery according to aspect [3], the second insulating material is disposed at least partially in contact with the negative electrode current collector.
[5] In the all-solid-state battery according to aspect [1] or [2], the electrode body includes an intermediate layer between the solid electrolyte layer and the negative electrode layer, and in an extending direction of the electrode body, an end of the intermediate layer is disposed at a substantially same position as an end of the negative electrode layer or an end of the second insulating material, or disposed inward with respect to the end of the negative electrode layer or the end of the second insulating material.
[6] In the all-solid-state battery according to aspect [5], the second insulating material is disposed at least partially in contact with the intermediate layer.
[7] In the all-solid-state battery according to aspect [1] or [2], the end of the solid electrolyte layer is at a substantially same position as the end of the first insulating material in an extending direction of the electrode body.
[8] In the all-solid-state battery according to aspect [1] or [2], the second insulating material is a stacked body that includes an adhesive layer and an insulating layer, the adhesive layer is disposed on a side closer to the negative electrode current collector, and the insulating layer is disposed on a side closer to the solid electrolyte layer.
[9] In the all-solid-state battery according to aspect [8], the adhesive layer is an acrylic adhesion layer, and the insulating layer contains polyethylene.

According to the present invention, an all-solid-state battery that can ensure adequate insulation can be provided.

### BRIEF DESCRIPTION OF THE DRAWINGS

FIG. 1 is part of a cross-sectional view showing a configuration of an all-solid-state battery according to a first embodiment;

FIG. 2 is part of a cross-sectional view showing a configuration of an all-solid-state battery according to a second embodiment;

FIG. 3 is part of a cross-sectional view showing a configuration of an all-solid-state battery according to a third embodiment;

FIG. 4 is part of a cross-sectional view showing a configuration of an all-solid-state battery according to a fourth embodiment; and

FIG. 5 is a cross-sectional view showing a configuration of a conventional all-solid-state battery.

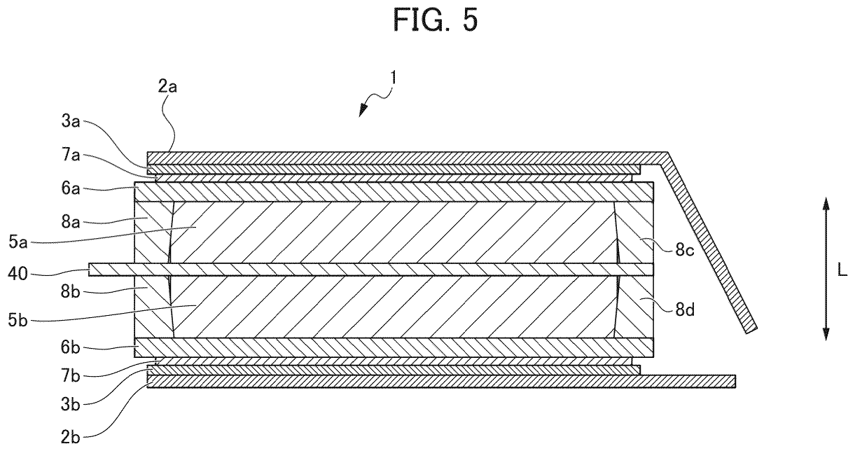

### DETAILED DESCRIPTION OF THE INVENTION

The following describes embodiments with reference to the drawings.

### First Embodiment

An all-solid-state battery of the present disclosure is described with reference to an all-solid-state battery 11 that is an embodiment.

The all-solid-state battery of the present disclosure includes an electrode body that includes a positive electrode current collector, a positive electrode layer, a solid electrolyte layer, a negative electrode layer, and a negative electrode current collector that are stacked in this order. The positive electrode current collector includes, on a surface closer to the positive electrode layer, a first insulating material adjacent to an end of the positive electrode layer, and the solid electrolyte layer is disposed in contact with the positive electrode layer and the first insulating material.

The all-solid-state battery of the present disclosure further includes a second insulating material at a portion that is between the negative electrode current collector and the solid electrolyte layer and faces an end of the solid electrolyte layer and an end of the first insulating material. The second insulating material is disposed in contact with the solid electrolyte layer such that the creepage distance from a surface of the negative electrode current collector closer to the negative electrode layer to a surface of the positive electrode current collector closer to the positive electrode layer is larger than a straight-line distance therebetween.

The all-solid-state battery of the present disclosure includes the first insulating material at the end of the positive electrode layer, and the second insulating material is disposed at a portion that is between the negative electrode current collector and the solid electrolyte layer and faces an end of the solid electrolyte layer and an end of the first insulating material such that the creepage distance from a surface of the negative electrode current collector closer to the negative electrode layer to a surface of the positive electrode current collector closer to the positive electrode layer is larger than the straight-line distance therebetween. Accordingly, adequate insulation can be ensured by the creepage distance.

More specifically, even in a situation in which the tab wires extending from the negative electrode current collectors of the cell structures are gathered in order for the function as a battery to be performed and a clearance between the tab wires and a positive electrode current collector is short due to the bend of the tab wires, a sufficient creepage distance can be secured. Accordingly, adequate insulation can be ensured.

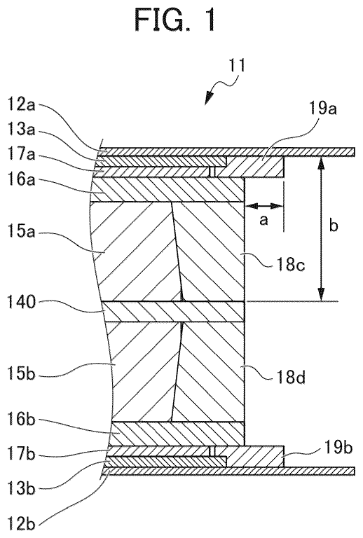

FIG. 1 is part of a cross-sectional view showing the configuration of the all-solid-state battery 11 according to the first embodiment. FIG. 1 shows an end of a cell structure of the all-solid-state battery 11. The all-solid-state battery 11 shown in FIG. 1 includes: a positive electrode formed of a positive electrode current collector 140 and a positive electrode active material layer (positive electrode layer) 15a or 15b; solid electrolyte layers 16a and 16b adjacent to the positive electrode active material layer (positive electrode layer) 15a or 15b; and a negative electrode formed of a lithium metal layer (negative electrode layer) 13a and a negative electrode current collector 12a or a lithium metal layer (negative electrode layer) 13b and a negative electrode current collector 12b.

The all-solid-state battery 11 shown in FIG. 1 includes an intermediate layer 17a between the lithium metal layer (negative electrode layer) 13a and the solid electrolyte layer 16a, and includes an intermediate layer 17b between the lithium metal layer (negative electrode layer) 13b and the solid electrolyte layer 16b. A first insulating material 18c is disposed at an end of the positive electrode active material layer (positive electrode layer) 15a. A first insulating material 18d is disposed at an end of the positive electrode active material layer (positive electrode layer) 15b.

In the all-solid-state battery 11 according to the first embodiment shown in FIG. 1, the ends of the intermediate layers 17a and 17b are disposed inward with respect to the ends of the lithium metal layers (negative electrode layers) 13a and 13b in the extending direction of the electrode body.

The all-solid-state battery 11 shown in FIG. 1 includes the first insulating materials 18c and 18d at the ends of the positive electrode layers 15a and 15b, and a second insulating material 19a is arranged at a portion that is between the negative electrode current collector 12a and the solid electrolyte layer 16a and faces an end of the solid electrolyte layer 16a and an end of the first insulating material 18c such that the creepage distance from a surface of the negative electrode current collector 12a closer to the negative electrode layer 13a to a surface of the positive electrode current collector 140 closer to the positive electrode layer 15a is larger than the straight-line distance therebetween (indicated by reference symbol b in the diagram).

In further detail, the second insulating material 19a of the all-solid-state battery 11 according to the first embodiment is disposed such that part of its surface overlaps with the end of the negative electrode layer 13a in the extending direction of the electrode body of the all-solid-state battery 11, covers the negative electrode 13a with the overlapping portion, and is disposed in contact with the negative electrode current collector 12a in a state of not being in contact with the end of the intermediate layer 17a. The other surface of the second insulating material 19a is in contact with the solid electrolyte layer 16a except for a portion indicated by the arrow “a” (hereinafter referred to as “the arrow-a-portion”) in FIG. 1.

In other words, in the all-solid-state battery 11 shown in FIG. 1, the second insulating material 19a has one surface partially in contact with the negative electrode layer 13a in the extending direction of the electrode body, with the remaining part being in contact with the negative electrode current collector 12a, whereas the surface opposite to the one surface in contact with the negative electrode layer 13a and the negative electrode current collector 12a is disposed so as to be partially in contact with the solid electrolyte layer 16a in a state where the arrow-a-portion in FIG. 1 protrudes from the end of the solid electrolyte layer 16a.

The all-solid-state battery 11 is made to function as a battery by, for example, gathering tab wires extending from the negative electrode current collectors 12a. At this time, even when the clearance between the tab wires and the positive electrode current collector 140 is short due to the bend of the tab wires, the presence of the arrow-a-portion of the second insulating material 19a that protrudes from the end of the solid electrolyte layer 16a allows for a large creepage distance from the surface of the negative electrode current collector 12a closer to negative electrode layer 13a to the surface of the positive electrode current collector 140 closer to the positive electrode layer 15a because the creepage distance is along the surface of the second insulating material 19a. Consequently, the all-solid-state battery 11 can secure a sufficient creepage distance and ensure adequate insulation.

The second insulating material 19a thus includes the arrow-a-portion protruding from the end of the solid electrolyte layer 16a. Accordingly, even in a situation in which the tab wires extending from the negative electrode current collectors 12a are gathered in order for the function as a battery to be performed, the tab wires are bent, and stress is concentrated at the bent part, since the mechanical strength is improved by the presence of the second insulating material 19a, breakage of the tab wires can be suppressed.

It should be noted that in the all-solid-state battery of the present disclosure, the distance (the arrow a in FIG. 1) by which the second insulating material protrudes from the solid electrolyte with which the second insulating material is in contact is not particularly limited. If the end of the second insulating material is positioned outward with respect to the end of the solid electrolyte in the extending direction of the electrode body, the aforementioned effects of the present invention can be achieved.

### Second Embodiment

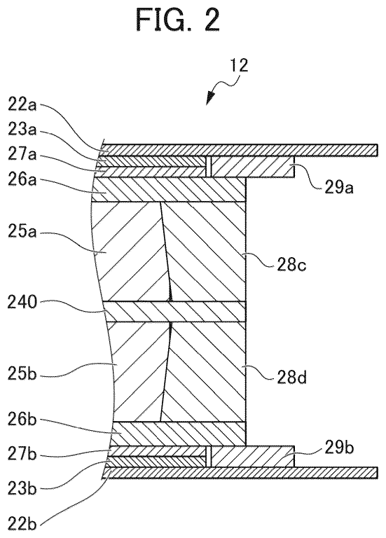

FIG. 2 shows part of a cross-sectional view illustrating the configuration of an all-solid-state battery 12 according to a second embodiment. FIG. 2 shows an end of a cell structure of the all-solid-state battery 12. The all-solid-state battery 12 shown in FIG. 2 includes: a positive electrode formed of a positive electrode current collector 240 and a positive electrode active material layer (positive electrode layer) 25a or 25b; solid electrolyte layers 26a and 26b adjacent to the positive electrode active material layer (positive electrode layer) 25a or 25b; and a negative electrode formed of a lithium metal layer (negative electrode layer) 23a and a negative electrode current collector 22a or a lithium metal layer (negative electrode layer) 23b and a negative electrode current collector 22b.

The all-solid-state battery 12 shown in FIG. 2 includes an intermediate layer 27a between the lithium metal layer (negative electrode layer) 23a and the solid electrolyte layer 26a, and includes an intermediate layer 27b between the lithium metal layer (negative electrode layer) 23b and the solid electrolyte layer 26b. A first insulating material 28c is disposed at an end of the positive electrode active material layer (positive electrode layer) 25a. A first insulating material 28d is disposed at an end of the positive electrode active material layer (positive electrode layer) 25b.

In the all-solid-state battery 12 according to the second embodiment shown in FIG. 2, the ends of the intermediate layers 27a and 27b are respectively disposed at substantially the same positions as the ends of the lithium metal layers (negative electrode layers) 23a and 23b in the extending direction of the electrode body.

The all-solid-state battery 12 shown in FIG. 2 includes the first insulating materials 28c and 28d at the ends of the positive electrode layers 25a and 25b, and a second insulating material 29a is arranged at a portion that is between the negative electrode current collector 22a and the solid electrolyte layer 26a and faces an end of the solid electrolyte layer 26a and an end of the first insulating material 28c such that the creepage distance from a surface of the negative electrode current collector 22a closer to the negative electrode layer 23a to a surface of the positive electrode current collector 240 closer to the positive electrode layer 25a is greater than the straight-line distance therebetween.

In further detail, the second insulating material 29a of the all-solid-state battery 12 according to the second embodiment is disposed in contact with the negative electrode current collector 22a without any portion overlapping with the negative electrode layer 23a and the intermediate layer 27a in the extending direction of the electrode body of the all-solid-state battery 12. The other surface of the second insulating material 29a is in contact with the solid electrolyte layer 26a.

In other words, in the all-solid-state battery 12 shown in FIG. 2, the second insulating material 29a has one surface entirely in contact with the negative electrode current collector 22a in the extending direction of the electrode body, and the surface opposite to the one surface in contact with the negative electrode current collector 22a is disposed so as to be partially in contact with the solid electrolyte layer 26a in a state of protruding from the end of the solid electrolyte layer 26a.

Accordingly, similar to the embodiment described above, for example, even in a situation in which the tab wires extending from the negative electrode current collectors 22a are gathered in order for the function as a battery to be performed, and the tab wires are bent, the all-solid-state battery 12 can secure a sufficient creepage distance and ensure adequate insulation, and suppress breakage and other damage to the tab wires by improvement of mechanical strength.

### Third Embodiment

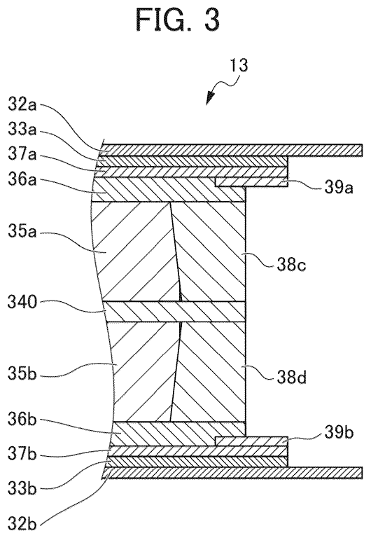

FIG. 3 shows part of a cross-sectional view illustrating the configuration of an all-solid-state battery 13 according to a third embodiment. FIG. 3 shows an end of a cell structure of the all-solid-state battery 13. The all-solid-state battery 13 shown in FIG. 3 includes: a positive electrode formed of a positive electrode current collector 340 and a positive electrode active material layer (positive electrode layer) 35a or 35b; solid electrolyte layers 36a and 36b adjacent to the positive electrode active material layer (positive electrode layer) 35a or 35b; and a negative electrode formed of a lithium metal layer (negative electrode layer) 33a and a negative electrode current collector 32a or a lithium metal layer (negative electrode layer) 33b and a negative electrode current collector 32b.

The all-solid-state battery 13 shown in FIG. 3 includes an intermediate layer 37a between the lithium metal layer (negative electrode layer) 33a and the solid electrolyte layer 36a, and includes an intermediate layer 37b between the lithium metal layer (negative electrode layer) 33b and the solid electrolyte layer 36b. A first insulating material 38c is disposed at an end of the positive electrode active material layer (positive electrode layer) 35a. A first insulating material 38d is disposed at an end of the positive electrode active material layer (positive electrode layer) 35b.

In the all-solid-state battery 13 according to the third embodiment shown in FIG. 3, the ends of the intermediate layers 37a and 37b are respectively disposed at substantially the same positions as the ends of the lithium metal layers (negative electrode layers) 33a and 33b in the extending direction of the electrode body.

The all-solid-state battery 13 shown in FIG. 3 includes the first insulating materials 38c and 38d at the ends of the positive electrode layers 35a and 35b, and a second insulating material 39a is arranged at a portion that is between the negative electrode current collector 32a and the solid electrolyte layer 36a and faces an end of the solid electrolyte layer 36a and an end of the first insulating material 38c such that the creepage distance from a surface of the negative electrode current collector 32a closer to the negative electrode layer 33a to a surface of the positive electrode current collector 340 closer to the positive electrode layer 35a is greater than the straight-line distance therebetween.

In further detail, the second insulating material 39a of the all-solid-state battery 13 according to the third embodiment is disposed in contact with the negative electrode current collector 32a without any portion overlapping with the negative electrode layer 33a and the intermediate layer 37a in the extending direction of the electrode body of the all-solid-state battery 13. The other surface of the second insulating material 39a is in contact with the solid electrolyte layer 36a.

In other words, in the all-solid-state battery 13 shown in FIG. 3, the second insulating material 39a has one surface entirely in contact with the intermediate layer 37a in the extending direction of the electrode body, and the surface opposite to the one surface in contact with the intermediate layer 37a is disposed so as to be partially in contact with the solid electrolyte layer 36a in a state of protruding from the end of the solid electrolyte layer 36a.

Accordingly, similar to the embodiments described above, for example, even in a situation in which the tab wires extending from the negative electrode current collectors 32a are gathered in order for the function as a battery to be performed, and the tab wires are bent, the all-solid-state battery 13 can secure a sufficient creepage distance and ensure adequate insulation, and suppress breakage and other damage to the tab wires by improvement of mechanical strength.

### Fourth Embodiment

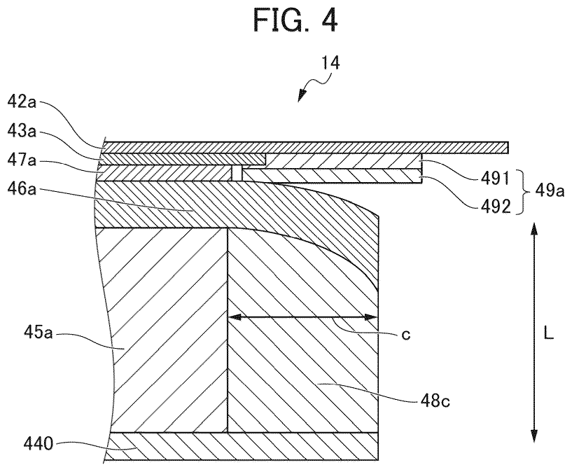

FIG. 4 shows part of a cross-sectional view illustrating the configuration of an all-solid-state battery 14 according to a fourth embodiment. FIG. 4 shows an end of a cell structure of the all-solid-state battery 14. The all-solid-state battery 14 shown in FIG. 4 includes: a positive electrode formed of a positive electrode current collector 440 and a positive electrode active material layer (positive electrode layer) 45a or 45b; solid electrolyte layers 46a and 46b adjacent to the positive electrode active material layer (positive electrode layer) 45a or 45b; and a negative electrode formed of a lithium metal layer (negative electrode layer) 43a and a negative electrode current collector 42a or a lithium metal layer (negative electrode layer) 43b and a negative electrode current collector 42b.

The all-solid-state battery 14 shown in FIG. 4 includes an intermediate layer 47a between the lithium metal layer (negative electrode layer) 43a and the solid electrolyte layer 46a, and includes an intermediate layer 47b between the lithium metal layer (negative electrode layer) 43b and the solid electrolyte layer 46b. A first insulating material 48c is disposed at an end of the positive electrode active material layer (positive electrode layer) 45a.

In the all-solid-state battery 14 according to the fourth embodiment shown in FIG. 4, the end of the intermediate layer 47a is disposed inward with respect to the end of the lithium metal layer (negative electrode layer) 43a in the extending direction of the electrode body.

In the all-solid-state battery 14 according to the fourth embodiment, in the first insulating material 48c, as the distance in the extending direction of the electrode body (the arrow c in FIG. 4) from the end adjacent to the positive electrode active material layer (positive electrode layer) 45a increases, the thickness of the electrode body in the stacking direction (the arrow L in FIG. 4) decreases. That is, the first insulating material 48c has a shape having an inclination in the stacking direction of the electrode body (the arrow L in FIG. 4), and the inclined portion forms a void space.

The all-solid-state battery 14 shown in FIG. 4 includes the first insulating material 48c at the end of the positive electrode layers 45a, and a second insulating material 49a is arranged at a portion that is between the negative electrode current collector 42a and the solid electrolyte layer 46a and faces an end of the solid electrolyte layer 46a and an end of the first insulating material 48c such that the creepage distance from a surface of the negative electrode current collector 42a closer to the negative electrode layer 43a to a surface of the positive electrode current collector 440 closer to the positive electrode layer 45a is greater than the straight-line distance therebetween.

In further detail, similar to the first embodiment described above, the second insulating material 49a of the all-solid-state battery 14 according to the fourth embodiment has one surface partially in contact with the negative electrode layer 43a in the extending direction of the electrode body of the all-solid-state battery 14, with the remaining part being in contact with the negative electrode current collector 42a, and the surface opposite to the one surface in contact with the negative electrode layer 43a and the negative electrode current collector 42a is disposed so as to be partially in contact with the solid electrolyte layer 46a in a state of protruding from the end of the solid electrolyte layer 46a.

That is, in the all-solid-state battery 14 shown in FIG. 4, the second insulating material 49a has one surface partially in contact with the negative electrode layer 43a in the extending direction of the electrode body, with the remaining part being in contact with the negative electrode current collector 42a, and the surface opposite to the one surface in contact with the negative electrode layer 43a and the negative electrode current collector 42a is disposed so as to be partially in contact with the solid electrolyte layer 46a in the state of protruding from the end of the solid electrolyte layer 46a.

In the all-solid-state battery 14 shown in FIG. 4, the second insulating material 49a is a stacked body that includes an adhesive layer 491 and an insulating layer 492. The adhesive layer 491 is disposed in contact with the negative electrode current collector 42a, and the insulating layer 492 is disposed in contact with the solid electrolyte layer 46a.

Accordingly, similar to the embodiments described above, for example, even in a situation in which the tab wires extending from the negative electrode current collectors 42a are gathered in order for the function as a battery to be performed, and the tab wires are bent, the all-solid-state battery 14 can secure a sufficient creepage distance and ensure adequate insulation, and suppress breakage and other damage to the tab wires by improvement of mechanical strength. In particular, in the all-solid-state battery 14 according to the fourth embodiment, the first insulating material 48c has the shape having the inclination in the stacking direction (the arrow L in FIG. 4) of the electrode body, and the void space is formed at the inclination. Since the second insulating material 49a is disposed in the void space region, a pressure due to presence of the second insulating material 49a can be reduced when the electrode body is pressed or laminated.

Hereinafter the components of the all-solid-state battery of the present disclosure are described.

### Positive Electrode

The positive electrode of the all-solid-state battery of the present disclosure includes a positive electrode current collector and a positive electrode layer. In the all-solid-state battery of the present disclosure, the positive electrode layer is in contact with the positive electrode current collector.

### Positive Electrode Current Collector

The positive electrode current collector included in the all-solid-state battery of the present disclosure is disposed in contact with the positive electrode layer, and has a function of collecting current in the positive electrode layer. The material of the positive electrode current collector is not particularly limited as long as it can collect current in the positive electrode layer. Examples of the material of the positive electrode current collector include aluminum, an aluminum alloy, stainless steel, nickel, iron, titanium, etc., among which at least one type selected from the group consisting of aluminum, an aluminum alloy, and stainless steel is preferred.

The shape of the positive electrode current collector is not particularly limited, and may be, for example, a foil shape, a plate shape, or the like. The thickness of the positive electrode current collector is not particularly limited, and may be similar to the thickness of a positive electrode current collector used for a positive electrode of a typical all-solid-state battery. The thickness of the positive electrode current collector may be, for example, in a range from 0.1 μm to 1 mm, inclusive.

### Positive Electrode Layer

The positive electrode layer is a layer that contains at least a positive electrode active material. The positive electrode active material contained in the positive electrode layer is not particularly limited as long as it is for use as a positive electrode layer of a typical all-solid-state battery. For example, in the case of a lithium-ion battery, the positive electrode active material may be a layered active material containing lithium, a spinel-type active material, an olivine-type active material, or the like. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), hetero-substituted Li-Mn spinel represented by Li₁₊ₓMn_{2-x-y}MyO₄ (x+y=2, M=at least one selected from Al, Mg, Co, Fe, Ni, and Zn), lithium titanate (an oxide containing Li and Ti), lithium metal phosphate (LiMPO₄, M=at least one selected from Fe, Mn, Co, and Ni), and the like.

The content of the positive electrode active material in the positive electrode layer may be, for example, in a range from 50 mass % to 99 mass %. The surface of the positive electrode active material may be covered with an oxide layer, such as a lithium niobate layer, a lithium titanate layer, or a lithium phosphate layer.

For the purpose of improving lithium ion conductivity, the positive electrode layer may optionally contain a solid electrolyte described later. The positive electrode layer may optionally contain a binder, a conductive assistant, or the like. As these substances, typical substances used for all-solid-state batteries can be used.

The thickness of the positive electrode layer is not particularly limited, and may be appropriately determined depending on the required battery performance. The thickness of the positive electrode layer may be, for example, in a range from 0.1 μm to 1 mm, inclusive.

In a case where the all-solid-state battery of the present disclosure includes an intermediate layer described later, it is preferable that the positive electrode layer have an area equivalent to that of the intermediate layer on the stack surface. This configuration can improve the energy density of the all-solid-state battery. The area of the positive electrode layer of the all-solid-state battery of the present disclosure may be, for example, 100% to the area of the intermediate layer at the maximum, 90% to 100%, or 80% to 90%.

A manufacturing method of the positive electrode layer is not particularly limited. It can be manufactured by a well-known method. The positive electrode layer can be manufactured by, for example, mixing materials for constituting the positive electrode layer with a solvent to form a slurry, applying the slurry onto the positive electrode current collector described above, and drying them.

### Solid Electrolyte Layer

The solid electrolyte layer is a layer that contains a solid electrolyte. The solid electrolyte layer is disposed in contact with the positive electrode layer and the first insulating material.

The material of the solid electrolyte is not particularly limited as long as it has lithium ion conductivity and is insulative. Any material generally used for all-solid-state-type lithium metal batteries may be used as the material of the solid electrolyte. Examples of the material include inorganic solid electrolytes such as sulfide solid electrolyte material, oxide solid electrolyte material, halide solid electrolyte, and lithium-containing salts, polymer-based solid electrolytes such as polyethylene oxide, and gel-based solid electrolytes that contain lithium-containing salt or lithium-ion-conductive ionic liquid. Among them, a sulfide solid electrolyte material is preferred in view of the highly conductive property of lithium ions, structural formability by pressing, and favorable interface bonding property.

The form of the solid electrolyte material is not particularly limited, and may be, for example, a granular form. In the solid electrolyte layer of the all-solid-state battery of the present disclosure, the content of the solid electrolyte is not particularly limited. The content of the solid electrolyte may be, for example, in a range from 50 mass % to 99 mass %.

The solid electrolyte layer may optionally contain a binder. For the purpose of providing a mechanical strength and flexibility, an adhesive agent may optionally be contained. As these substances, typical substances used for all-solid-state batteries can be used.

The solid electrolyte layer may be disposed such that its end is at substantially the same position as the end of the first insulating material in the extending direction of the electrode body of the all-solid-state battery of the present disclosure.

In the electrode body having such a shape, the solid electrolyte layer does not protrude from the end surface of the electrode body. Accordingly, for example, when a pressure of a roll press or the like is applied in the electrode body manufacturing process, the solid electrolyte layer is less likely to crack.

A manufacturing method of the solid electrolyte layer is not particularly limited. It can be manufactured by a well-known method. The solid electrolyte layer can be manufactured by, for example, mixing the materials for constituting the solid electrolyte layer with a solvent to form a slurry, applying the slurry onto a base material, and drying them.

### Negative Electrode

The negative electrode of the all-solid-state battery of the present disclosure includes a negative electrode current collector and a negative electrode layer. In the all-solid-state battery of the present disclosure, the negative electrode layer is in contact with the negative electrode current collector.

### Negative Electrode Current Collector

The negative electrode current collector included in the all-solid-state battery of the present disclosure is disposed in contact with the negative electrode layer, and has a function of collecting current in the negative electrode layer. The material of the negative electrode current collector is not particularly limited as long as it can collect current in the negative electrode layer. Preferably, it is made of a material having a high electrical conductivity. The material having a high electrical conductivity is, for example, a metal containing at least one metal element selected from the group consisting of silver, palladium, gold, platinum, aluminum, copper, and nickel, or an alloy such as stainless steel, or a non-metal such as carbon (C).

In consideration not only of the high conductivity but also of the manufacturing cost, it is preferable that among the foregoing materials having high electrical conductivities, at least one selected from the group consisting of copper, stainless steel, and nickel be used. In particular, stainless steel is unlikely to react with the negative electrode active material, the positive electrode active material, and the solid electrolyte. Accordingly, use of stainless steel as the material of the negative electrode current collector can reduce the internal resistance of the all-solid-state battery.

The shape of the negative electrode current collector is not particularly limited, and may be, for example, a foil shape, a plate shape, a mesh shape, a non-woven fabric shape, a foamed shape, or the like. For the purpose of improving the adhesiveness with the negative electrode layer, on the surface of the negative electrode current collector, a carbon layer or the like may be disposed, or the surface may be roughened.

The thickness of the negative electrode current collector is not particularly limited, and may be similar to the thickness of a negative electrode current collector used for a negative electrode of a typical all-solid-state battery. The thickness of the negative electrode current collector may be, for example, in a range from 0.1 μm to 1 mm, inclusive.

### Negative Electrode Layer

The negative electrode layer is a layer that contains a negative electrode active material that transfers electrons to and from lithium ions. The negative electrode active material contained in the negative electrode layer is not particularly limited as long as it can be used for a negative electrode layer of a typical all-solid-state battery. However, it is preferable to use a material that has a high electron conductance in order to allow lithium ions to be reversibly released and absorbed and allow electrons to be easily transported. Examples of such a negative electrode active material include silicon-based active materials such as silicon and silicon alloys, carbon-based active materials such as graphite and hard carbon, various oxide-based active materials such as lithium titanate, lithium-based active materials such as lithium metal and lithium alloys, and the like. Any one of the foregoing materials may be used alone as the negative electrode active material, or two or more of them may be used in combination.

In the all-solid-state battery of the present disclosure, the negative electrode layer may be made of either lithium metal or lithium metal alloy alone, or both of lithium metal and lithium metal alloy that are mixed. The negative electrode layer made of either lithium metal or a lithium metal alloy alone or both of lithium metal and a lithium metal alloy that are mixed has a large capacitance per unit weight. Accordingly, an all-solid-state battery having a high high-capacity can be achieved.

The content of the negative electrode active material in the negative electrode layer may be, for example, in a range from 30 mass % to 100 mass %.

For the purpose of improving the lithium ion conductivity, the negative electrode layer may optionally contain solid electrolyte described above. The negative electrode layer may optionally contain a binder, a conductive assistant, or the like. As these substances, typical substances used for all-solid-state batteries can be used.

The thickness of the negative electrode layer is not particularly limited, and may be appropriately determined depending on the required battery performance. The thickness of the negative electrode layer may be, for example, in a range from 0.1 μm to 1 mm, inclusive.

A manufacturing method of the negative electrode layer is not particularly limited. It can be manufactured by a well-known method. The negative electrode layer can be manufactured by, for example, mixing materials for constituting the negative electrode layer with a solvent to form a slurry, applying the slurry onto the negative electrode current collector described above, and drying them.

### Intermediate Layer

In the case where the all-solid-state battery of the present disclosure includes the intermediate layer, the intermediate layer is arranged between the solid electrolyte and the negative electrode layer. In the case where the negative electrode layer of the all-solid-state battery of the present disclosure is the layer made only of lithium metal or lithium metal alloy, or both of them mixed together, presence of the intermediate layer between the solid electrolyte layer and the negative electrode layer can suppress non-uniform deposition of dendrites on the boundary between the solid electrolyte layer and the negative electrode layer, and can improve the interface adhesiveness.

The intermediate layer is a layer that has electron conductivity and ion conductivity. Since the intermediate layer has the ion conductivity, the layer allows, for example, lithium ions to pass therethrough. Accordingly, as the all-solid-state battery is repetitively charged and discharged, lithium ions (Li⁺) moving from the solid electrolyte layer toward the negative electrode layer pass through the intermediate layer. The presence of the intermediate layer allows lithium metal to be uniformly deposited between the intermediate layer and the negative electrode layer. In the case where the intermediate layer has a flexibility that can follow change in volume of each layer due to charging and discharging, even after repetitive charging and discharging of the all-solid-state battery, the interface adhesiveness can be maintained, and the durability of the all-solid-state battery can be improved.

In the extending direction of the electrode body of the all-solid-state battery of the present disclosure, the end of the intermediate layer may be disposed at substantially the same position as the end of the negative electrode layer or the end of the second insulating material, or disposed inward with respect to the end of the negative electrode layer or the end of the second insulating material. Accordingly, the effect resulting from disposing the intermediate layer described above can be sufficiently achieved.

The material constituting the intermediate layer is not particularly limited. The intermediate layer may contain, for example, amorphous carbon, metallic nano-particles, and a binder as a binding agent.

Unlike graphite and the like, amorphous carbon does not react with lithium metal or form an alloy. Accordingly, formation of dendrites can be suppressed, and the cycle characteristic of the all-solid-state battery can be improved.

Examples of the amorphous carbon include carbon blacks such as acetylene black, furnace black, and Ketjenblack, coke, activated carbon, and the like. The amorphous carbon may be graphitizable carbon (soft carbon), non-graphitizable carbon (hard carbon), CNT (carbon nanotubes), fullerene, graphene, or the like.

The metallic nano-particles contained in the intermediate allow the electron conductivity of the intermediate layer to be improved. As a result, lithium metal can be more uniformly deposited. The metallic nano-particles are not particularly limited, and examples of which include metallic nano-particles, such as particles of tin, silicon, zinc, magnesium, gold, platinum, palladium, silver, aluminum, bismuth, and antimony.

The binder contained in the intermediate layer maintains the structure of the intermediate layer, and improves the adhesiveness between the particles constituting the intermediate layer, and between the intermediate layer and the solid electrolyte layer. The binder is not particularly limited, and may be any typical binder used for all-solid-state batteries.

### First Insulating Material

The first insulating material is arranged adjacent to the end of the positive electrode, on the surface of the positive electrode current collector closer to the positive electrode layer. The first insulating material is thus disposed at the end of the positive electrode layer. Accordingly, when the tab wires extending from the negative electrode current collectors of the cell structures are gathered in order for the function as a battery to be performed, bend of the tab wires allows for avoidance of contact between the tab wires and the end of the positive electrode to prevent or reduce electrical short circuits, and prevent or reduce occurrence of cracks due to change in volume caused by repetitive charging and discharging, and also prevent or reduce electrical short circuits due to cracks.

The shape of the first insulating material is not limited as long as it is arranged at the end of the positive electrode layer. The size of the first insulating material is not particularly limited as long as it has a thickness equal to or less than the thickness of the positive electrode layer in the stacking direction of the electrode body, and is disposed at the end of the positive electrode layer while being in contact partially or entirely with the end surface of the positive electrode layer in the extending direction of the electrode body.

The material of the first insulating material is not particularly limited as long as it can exhibit adequate insulation, and may be what is called an insulator other than a semiconductor or a conductor. The material of the first insulating material can be appropriately selected depending on a property intended to be added to the insulation.

Examples of the material of the first insulating material include polypropylene, alumina, anodized aluminum, boehmite, zirconia, aluminum nitride, silicon nitride, etc.

The first insulating material may have a thickness in the stacking direction of the electrode body that decreases as the distance from the end adjacent to the positive electrode layer increases in the extending direction of the electrode body of the all-solid-state battery of the present disclosure. The first insulating material having such a shape has, for example, the inclination as shown in FIG. 4, and the void space is formed at the inclined portion. Since the second insulating material of the present disclosure can be disposed in the void space region, a pressure can be reduced when the electrode body is pressed or laminated.

A manufacturing method of the first insulating material is not particularly limited. The first insulating material can be manufactured by, for example, applying the slurry containing the material of the first insulating material onto the positive electrode current collector where the positive electrode layer is formed, and drying them.

### Second Insulating Material

The second insulating material is arranged at a portion that is between the negative electrode current collector and the solid electrolyte layer and faces an end of the solid electrolyte layer and an end of the first insulating material. The second insulating material is disposed in contact with the solid electrolyte layer such that the creepage distance from a surface of the negative electrode current collector closer to the negative electrode layer to a surface of the positive electrode current collector closer to the positive electrode layer is greater than a straight-line distance therebetween.

By virtue of the above-described structure of the all-solid-state battery of the present disclosure, even in a situation in which the tab wires extending from the negative electrode current collectors of the cell structures are gathered in order for the function as a battery to be performed, and a clearance between the tab wires and the positive electrode current collector is short due to bend of the tab wires, adequate insulation can be ensured because a large creepage distance is achieved from the surface of the negative electrode current collector closer to the negative electrode layer to the surface of the positive electrode current collector closer to the positive electrode layer.

The second insulating material may be a stacked body that includes an adhesive layer and an insulating layer. The adhesive layer may be disposed on a side closer to the negative electrode current collector, and the insulating layer may be disposed on a side closer to the solid electrolyte layer. Due to this configuration, the second insulating material can be attached to a desired position on the electrode body by means of the adhesive layer. Such a second insulating material may have, for example, a tape-like form that includes release paper on the adhesive layer side.

In the case where the second insulating material is a stacked body that includes an adhesive layer and an insulating layer, the material of the adhesive layer is not particularly limited, and may be formed of any of well-known materials. Among such materials, an acrylic adhesion layer is preferred because it is a material unlikely to electrochemically react during charging and discharging. The material of the insulating layer is not particularly limited and may be formed of any of well-known materials. Among such materials, a material containing polyethylene is preferred because it is a material unlikely to electrochemically react during charging and discharging.

A manufacturing method of the second insulating material is not particularly limited. The material can be manufactured by, for example, forming the adhesive layer by way of applying a slurry containing the material of the adhesive layer onto a base material having release paper and drying them, and then applying a slurry containing the material of the insulating layer onto the formed adhesive layer and drying them.

### All-Solid-State Battery Manufacturing Method

A manufacturing method of the all-solid-state battery of the present disclosure is not particularly limited, and the all-solid-state battery may be manufactured according to a well-known method. For example, the negative electrode layer, the intermediate layer, the solid electrolyte layer, and the positive electrode layer are stacked in this order, and the first insulating materials are formed at the opposite ends of the positive electrode layer. Subsequently, the second insulating material of a desired size is attached to a desired position, thereby allowing each cell structure to be fabricated. After fabrication of the cell structures, they may be stacked, and integrated by optionally pressing them.

In the foregoing, preferred embodiments of the present invention have been described. However, the present invention is not limited to the embodiments described above, and modifications or improvements within the range allowing achievement of the object of the present invention are encompassed in the present invention.

### EXPLANATION OF REFERENCE NUMERALS

1, 11, 12, 13, 14: All-solid-state battery
2a, 2b, 12a, 12b, 22a, 22b, 32a, 32b, 42a: Negative electrode current collector
3a, 3b, 13a, 13b, 23a, 23b, 33a, 33b, 43a: Lithium metal layer (negative electrode layer)
40, 140, 240, 340, 440: Positive electrode current collector
5a, 5b, 15a, 15b, 25a, 25b, 35a, 35b, 45a: Positive electrode active material layer (positive electrode layer)
6a, 6b, 16a, 16b, 26a, 26b, 36a, 36b, 46a: Solid electrolyte layer
7a, 7b, 17a, 17b, 27a, 27b, 37a, 37b, 47a: Intermediate layer
8a, 8b, 8c, 8d, 18c, 18d, 28c, 28d, 38c, 38d, 48c: First insulating material
19a, 19b, 29a, 29b, 39a, 39b, 49a: Second insulating material
491: Adhesive layer
492: Insulating layer
L: Electrode body stacking direction
a: Region of the second insulating material protruding from the solid electrolyte layer (region contributing to the creepage distance from the surface of the negative electrode current collector closer to the negative electrode layer to the surface of the positive electrode current collector closer to the positive electrode layer)
b: Straight-line distance from the surface of the negative electrode current collector closer to the negative electrode layer to the surface of the positive electrode current collector closer to the positive electrode layer
c: Distance from the end of the first insulating material adjacent to the positive electrode active material layer (positive electrode layer) in the extending direction of the electrode body

What is claimed is:

1. An all-solid-state battery, comprising an electrode body including a positive electrode current collector, a positive electrode layer, a solid electrolyte layer, a negative electrode layer, and a negative electrode current collector that are stacked in this order, wherein
the positive electrode current collector includes, on a surface thereof closer to the positive electrode layer, a first insulating material adjacent to an end of the positive electrode layer,
the solid electrolyte layer is disposed in contact with the positive electrode layer and the first insulating material,
a second insulating material is arranged at a portion that is between the negative electrode current collector and the solid electrolyte layer and faces an end of the solid electrolyte layer and an end of the first insulating material, and
the second insulating material is disposed in contact with the solid electrolyte layer such that a creepage distance from a surface of the negative electrode current collector closer to the negative electrode layer to a surface of the positive electrode current collector closer to the positive electrode layer is greater than a straight-line distance therebetween.

2. The all-solid-state battery according to claim 1, wherein
in the first insulating material, as a distance in an extending direction of the electrode body from an end adjacent to the positive electrode layer increases, a thickness in a stacking direction of the electrode body decreases.

3. The all-solid-state battery according to claim 1, wherein
the second insulating material is disposed so as to overlap with an end of the negative electrode layer in an extending direction of the electrode body.

4. The all-solid-state battery according to claim 3, wherein
the second insulating material is disposed at least partially in contact with the negative electrode current collector.

5. The all-solid-state battery according to claim 1, wherein
the electrode body includes an intermediate layer between the solid electrolyte layer and the negative electrode layer, and
in an extending direction of the electrode body, an end of the intermediate layer is disposed at a substantially same position as an end of the negative electrode layer or an end of the second insulating material, or disposed inward with respect to the end of the negative electrode layer or the end of the second insulating material.

6. The all-solid-state battery according to claim 5, wherein
the second insulating material is disposed at least partially in contact with the intermediate layer.

7. The all-solid-state battery according to claim 1, wherein
the end of the solid electrolyte layer is at a substantially same position as the end of the first insulating material in an extending direction of the electrode body.

8. The all-solid-state battery according to claim 1, wherein
the second insulating material is a stacked body that includes an adhesive layer and an insulating layer,
the adhesive layer is disposed on a side closer to the negative electrode current collector, and
the insulating layer is disposed on a side closer to the solid electrolyte layer.

9. The all-solid-state battery according to claim 8, wherein
the adhesive layer is an acrylic adhesion layer, and
the insulating layer contains polyethylene.
